(19) United States
(12) Patent Application Publication
(10) Pub. No.: US 2025/0197590 A1
(43) Pub. Date: Jun. 19, 2025

(54) METHOD OF PRODUCING NANOCELLULOSE COMPOSITION FROM SOLID OR LIQUID CELLULOSE-RICH ORGANIC WASTE

(71) Applicant: Harvest Nano Inc., Ann Arbor, MI (US)

(72) Inventor: Refael Aharon, Ann Arbor, MI (US)

(21) Appl. No.: 19/065,596

(22) Filed: Feb. 27, 2025

Related U.S. Application Data
(63) Continuation-in-part of application No. PCT/US23/34849, filed on Oct. 10, 2023.
(60) Provisional application No. 63/378,912, filed on Oct. 10, 2022.

(51) Int. Cl. C08J 11/10; C08L 1/02

(52) U.S. Cl. CPC C08J 11/105; C08L 1/02; C08J 2301/02; C08L 2207/20

(57) ABSTRACT

A method of producing a nanocellulose composition from solid or liquid cellulose-rich organic waste includes providing a feedstock comprising solid or liquid cellulose-rich organic waste, screening the feedstock to generate a screened feedstock, preparing the screened feedstock to generate a prepared feedstock, subjecting the prepared feedstock to a first reaction bath to generate an unrefined nanocellulose composition, washing the unrefined nanocellulose composition to generate a semi-refined nanocellulose composition, and separating the semi-refined nanocellulose composition to generate a nanocellulose composition.

### CROSS-REFERENCE TO RELATED APPLICATIONS

This application is a continuation-in-part of PCT International Patent Application No. PCT/US2023/034849, filed on Oct. 10, 2023, which claims priority to U.S. Provisional Patent Application No. 63/378,912, filed on Oct. 10, 2022, the entireties of which are incorporated herein by reference for all purposes.

### TECHNICAL FIELD

The present disclosure relates generally to large-scale production of nanocellulose compositions, and more particularly to a method of producing a nanocellulose composition from solid or liquid cellulose-rich organic waste.

### BACKGROUND

This section provides background information related to the present disclosure which is not necessarily prior art.

Plant cell walls are complex structures comprised of diverse configurations of interlocking polysaccharides. Based on its structure and composition, a plant cell wall is divided into three different layers: the middle lamella, the primary cell wall, and the secondary cell wall. The middle lamella contains a high amount of lignin and is primarily responsible for binding the primary cell walls of adjoining plant cells. The primary cell wall is approximately 30-1000 nanometers (nm) thick and contains three main components: cellulose, hemicellulose, and pectin, where cellulose microfibrils are arranged crosswise. The secondary cell wall is further divided into three layers.

With further regard to the above-described existence of cellulose in plant cell walls, cellulose is a well-organized fibrillar arrangement that is therefore primarily responsible for the mechanical strength of plants. Cellulose is considered to be one of the most abundant organic compounds derived from plant biomass. In this regard, most cellulose is produced naturally by plants, with total amounts exceeding 500 billion metric tons each year worldwide. Cellulose biopolymers are used in such industries which produce paper, insulation materials, textiles, composite materials, chemicals, etc. Although cellulose is a polysaccharide, its crystallinity is imperfect such that a significant portion of the cellulose structure is less active and can be referred to as amorphous.

The degree of crystallinity of native cellulose usually ranges from 40% to 70% depending on the origin of the cellulose and the isolation method. The cellulose is present in the form of the microfibrils, which are bound together by lignin and hemicellulose. These microfibrils are very fine fibrils (i.e., fiber-like strands) having a width of 10-50 micrometers (μm). Cellulose is a natural stable polymer, containing a hydrogen bond network, which does not dissolve in common aqueous solvents and has a 60-270° C./500-518° F./533-543 K melting point.

Many types of organic waste (i.e., solid and liquid organic waste) such as textile waste, agricultural waste, industrial waste, animal waste, and human waste typically contain a relatively high percentage of cellulose. In this regard, many types of organic waste may be considered as “cellulose-rich”.

Nanocellulose, discovered in 1980, is a relatively new material which is substantially different than cellulose. Nanocellulose is obtained by removing the amorphous parts (i.e., lignin and hemicellulose) from cellulose and downsizing the cellulose fibers such that only the active nano scale parts remain. In this regard, nanocellulose is comprised of cellulose molecules with at least one dimension in nanoscale (1-100 nanometers (nm)) and with known properties of nanocellulose (e.g., zeta potential, strength, weight, etc.). The characteristic properties of nanocellulose, including crystallinities, surface area, zeta potential, and mechanical properties, vary with the extraction methods and processing techniques which produce the nanocellulose. Such characteristic properties of nanocellulose typically depend on the technique and synthesis conditions of the nanocellulose, which determines its dimensions, composition, and properties.

Over the years, the production (i.e., commercial or large-scale production) of nanocellulose (i.e., nanocellulose compositions) has been limited and is considered to be relatively expensive due to the costs of raw cellulosic materials, equipment, and production processes. Despite the potential of nanocellulose, a relatively low quantity of nanocellulose is produced each year worldwide. In this regard, there is currently an increased focus on cost-effective production of nanocellulose, especially since research has increasingly shown nanocellulose to provide many advantages in industrial applications. For example, nanocellulose is believed to be a replacement for synthetic materials due to having superior mechanical properties and being more environmentally-friendly. Moreover, in addition to nanocellulose being used to formulate completely new types of biomaterials, cellulose nanocomposites are being used in medical, space, building, automotive, electronics, packaging, construction, and wastewater treatment applications. Recent developments have shown the ability to increase the strength of sheets of paper with the addition of nanocellulose particles to paper compositions. In this regard, such sheets of paper exhibit admirable mechanical properties. These mechanical properties of such sheets of paper are at least 2-5 times higher than those of conventional sheets of paper produced from conventional refining processes without the addition of nanocellulose particles.

Moreover, in recent years within the composite industry, there has been a substantial growth in interest in the use of nanocellulose as a polymer reinforcement in order to create high-performance biomaterials. The core reason for the appeal of nanocellulose is that material with a higher uniformity and fewer defects with enhanced mechanical properties can be achieved by extracting the nanocellulose from cellulosic material. Nanocellulose can be used as a reinforcing filler to prepare composites with solutions of water-soluble polymers to modify the viscosity and increase mechanical properties of dry composites. Of utmost importance has been the addition of nanocellulose to biodegradable polymers, which permits both the improvement of mechanical properties and speeds up the rate of biodegradation. Nanocellulose is a natural biodegradable material, highly suitable for the biomedical industry. Pure nanocellulose is nontoxic for people and it is biocompatible. Nanocellulose can be utilized for health care applications such as personal hygiene products, cosmetics, and biomedicines. Moreover, nanocellulose has electrical conductivity and therefore has increased potential for use in electronics. Nanocellulose-based materials are carbon-neutral, nontoxic, sustainable, and recyclable. In this regard, considering at least what is discussed above, nanocellulose is a promising, futuristic new material with a wide range of industrial applications.

Considering at least the above-mentioned advantages relating to the mechanical properties and industrial applications of nanocellulose, as well as the substantial growth and increasing demand for nanocellulose, there is currently an unaddressed need for large-scale, cost-effective, and environmentally-friendly production of nanocellulose compositions.

### SUMMARY

This section provides a general summary of the present disclosure and is not a comprehensive disclosure of its full scope or all of its features.

The present disclosure aims to address the aforementioned need for large-scale, cost-effective, and environmentally-friendly production of nanocellulose compositions. In this regard, at least one embodiment of the present disclosure provides a method of producing a nanocellulose composition from solid or liquid cellulose-rich organic waste. The method is advantageously capable of at least producing a nanocellulose composition in a manner which is large-scale, cost-effective, and environmentally-friendly.

According to at least one embodiment, a method of producing a nanocellulose composition from solid or liquid cellulose-rich organic waste includes providing a feedstock comprising solid or liquid cellulose-rich organic waste, screening the feedstock to generate a screened feedstock, preparing the screened feedstock to generate a prepared feedstock, subjecting the prepared feedstock to a first reaction bath to generate an unrefined nanocellulose composition, washing the unrefined nanocellulose composition to generate a semi-refined nanocellulose composition, and separating the semi-refined nanocellulose composition to generate a nanocellulose composition.

According to at least one embodiment, the feedstock may comprise solid cellulose-rich organic waste selected from the group consisting of solid agricultural waste, solid industrial waste, solid textile waste, solid municipal waste, and solid forestry waste.

According to at least one embodiment, the feedstock may comprise liquid cellulose-rich organic waste selected from the group consisting of agricultural wastewater, animal manure, industrial wastewater, textile wastewater, municipal wastewater, and beverage manufacturer wastewater.

According to at least one embodiment, screening the feedstock to generate the screened feedstock may include characterizing the feedstock as solid or liquid, analyzing the feedstock, and removing unwanted matter from the feedstock.

According to at least one embodiment, analyzing the feedstock may include determining at least one of the weight, density, chemical composition, water/moisture content (RH), acidity (pH), or electrical conductivity (EC) of the feedstock.

According to at least one embodiment, removing the unwanted matter from the feedstock may include removing at least one of metal particles, plastic particles, synthetic fibers, glass particles, dirt particles, dust particles, sand particles, soil particles, construction aggregate particles, dead skin particles, ions, hair particles, PFAS, fats, oils, detergents, or dyes from the feedstock.

According to at least one embodiment, preparing the screened feedstock to generate the prepared feedstock may include subjecting the screened feedstock to a physical pretreatment process to downsize the screened feedstock and generate the prepared feedstock.

According to at least one embodiment, subjecting the screened feedstock to the physical pretreatment process to downsize the screened feedstock may include subjecting the screened feedstock to at least one of a grinding process, a cutting process, a high-pressure homogenization process, a shear homogenization process, an electron beam process, a radiation process, a cavitation process, a sonication process, a vibration process, or a crushing process.

According to at least one embodiment, preparing the screened feedstock to generate the prepared feedstock may further include analyzing the prepared feedstock after the screened feedstock has been downsized, and wherein analyzing the prepared feedstock may include determining at least one of the weight, volume, acidity (pH), temperature, viscosity, or electrical conductivity (EC) of the prepared feedstock.

According to at least one embodiment, subjecting the prepared feedstock to the first reaction bath to generate the unrefined nanocellulose composition may include conveying the prepared feedstock to the first reaction bath, subjecting the prepared feedstock to a physical reaction process of the first reaction bath, and subjecting the prepared feedstock to a chemical reaction process of the first reaction bath to generate the unrefined nanocellulose composition.

According to at least one embodiment, conveying the prepared feedstock to the first reaction bath may include conveying the prepared feedstock to the first reaction bath by way of a conveyor netting, a pump, gravity, or air pressure.

According to at least one embodiment, subjecting the prepared feedstock to the physical reaction process of the first reaction bath may include subjecting the prepared feedstock to at least one of a grinding process, a high-pressure homogenization process, a shear hydrolysis homogenization process, a hydrolysis process, a cavitation process, an electron beam process, a radiation process, a sonication process, a vibration process, a heating process, or a crushing process of the first reaction bath.

According to at least one embodiment, subjecting the prepared feedstock to the chemical reaction process of the first reaction bath may include adding and mixing at least one selected from the group consisting of boric acid, formic acid, phosphoric acid, sodium hydroxide, hydrogen peroxide, trioxygen, citric acid, acetic acid, hydrobromide, hydrochloric acid, nitric acid, liquid ions, eutectic solvents, sodium chlorite, ethanol, carboxylic acid, phosphoric based acid, sulfuric based acids, TEMPO, polyethylene amine, deionized water, water, and any combination thereof, with the prepared feedstock.

According to at least one embodiment, subjecting the prepared feedstock to the first reaction bath to generate the unrefined nanocellulose composition may further include subjecting the prepared feedstock to a biochemical reaction process of the first reaction bath to generate the unrefined nanocellulose composition.

According to at least one embodiment, subjecting the prepared feedstock to the biochemical reaction process of the first reaction bath may include adding and mixing hydrolysis enzymes with the prepared feedstock.

According to at least one embodiment, the method may further include optionally subjecting the prepared feedstock to one or more additional reaction baths, after the first reaction bath, to generate the unrefined nanocellulose composition.

According to at least one embodiment, washing the unrefined nanocellulose composition to generate the semi-refined nanocellulose composition may include washing the unrefined nanocellulose composition by way of a water immersion process, a water spray process, a dialysis process, a reverse osmosis process, or an acid removal process to thereby wash chemicals and/or unwanted reaction bath byproduct from the unrefined nanocellulose composition and generate the semi-refined nanocellulose composition.

According to at least one embodiment, separating the semi-refined nanocellulose composition to generate the nanocellulose composition may include separating the semi-refined nanocellulose composition from remaining unwanted reaction bath byproduct to generate the nanocellulose composition.

According to at least one embodiment, the nanocellulose composition may be undehydrated and in the form of a gel.

According to at least one embodiment, the method may further include separating the nanocellulose composition to exit a system at different exit points, wherein the separating of the nanocellulose composition may be based on particle size and/or quality of the nanocellulose composition.

According to at least one embodiment, the method may further include optionally dehydrating the nanocellulose composition.

According to at least one embodiment, the nanocellulose composition that has been optionally dehydrated may be in the form of a powder.

According to at least one embodiment, the method may further include finalizing the nanocellulose composition, wherein finalizing the nanocellulose composition may include adding and mixing at least one of additive polymers, additive sawdust, additive pulp, additive paint, additive carbon fibers, additive chemicals, or additive metals with the nanocellulose composition to finalize the nanocellulose composition.

According to at least one embodiment, the nanocellulose composition may be in the form of a powder or a gel after the nanocellulose composition has been finalized.

According to at least one embodiment, the method may further include packaging the nanocellulose composition after the nanocellulose composition has been finalized.

### BRIEF DESCRIPTION OF THE DRAWINGS

The present disclosure will become more fully understood from the detailed description and the accompanying drawings, wherein:

FIGS. 1-7 are flowcharts schematically illustrating a method of producing a nanocellulose composition from solid or liquid cellulose-rich organic waste, according to at least one embodiment.

### DETAILED DESCRIPTION

As required, one or more detailed embodiments of the present disclosure are disclosed herein, however, it is to be understood that the disclosed one or more embodiments are merely illustrative of the present disclosure that may be embodied in various and alternative forms. Therefore, specific details disclosed herein are not to be interpreted as limiting, but merely as a representative basis for teaching one skilled in the art to variously employ the present disclosure. Moreover, the use of the word “or” in reference to a list of two or more items covers all of the following interpretations of the word: any one of the items in the list, all of the items in the list, and any combination of the items in the list.

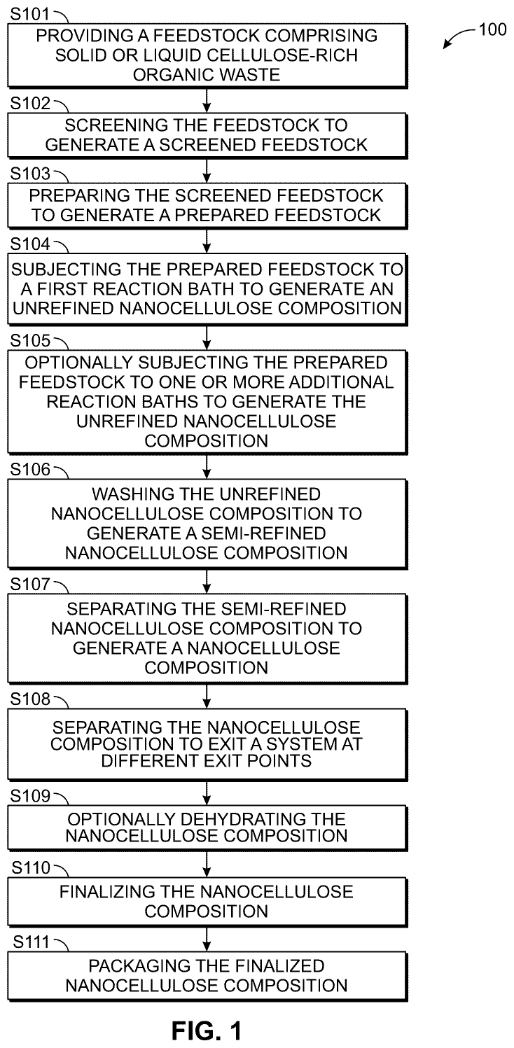

Referring generally to FIGS. 1-7, as will be further described herein in greater detail, at least one embodiment of the present disclosure provides a method 100 of producing a nanocellulose composition from solid or liquid cellulose-rich organic waste. As will become evident to those skilled in the art, the method 100 is advantageously capable of at least producing a nanocellulose composition in a manner which is large-scale, cost-effective, and environmentally-friendly. Moreover, it is to be understood by those skilled in the art that the method 100 may be carried out in any desired or appropriate production environment (e.g., relatively large or small production facilities) and by using any production system, machine, equipment, etc. as desired or deemed appropriate.

Referring to FIG. 1, the method 100 begins at step S101 thereof. According to at least one embodiment, step S101 of the method 100 includes providing a feedstock (e.g., raw material) comprising solid or liquid cellulose-rich organic waste (e.g., recycled or virgin solid or liquid cellulose-rich organic waste). According to the present disclosure, organic waste that is referred to as “cellulose-rich” preferably contains at least 15 wt. % cellulose. It is to be appreciated, however, that various solid or liquid organic waste advantageously contains substantially greater amounts of cellulose (i.e., substantially greater than 15 wt. % cellulose), which is ideal for efficiently producing a greater amount of nanocellulose composition while carrying out the method 100. For example, various agricultural waste (e.g., various crops, etc.) may contain approximately 30-60 wt. % cellulose, various forestry waste (e.g., wood, bark, etc.) may contain 41-53 wt. % cellulose, and various textile waste (e.g., cotton, etc.) may contain 90-99 wt. % cellulose.

With further regard to step S101 of the method 100, according to at least one embodiment, as non-limiting examples, the feedstock may comprise solid cellulose-rich organic waste selected from the group consisting of solid agricultural waste (e.g., crops such as corn, wheat, soybeans, etc.), solid industrial waste, solid textile waste (e.g., cotton, etc.), solid municipal waste (e.g., solid human sewage, garbage, etc.), and solid forestry waste (e.g., wood, bark, etc.). Alternatively, or in addition, according to at least one embodiment, as non-limiting examples, the feedstock may comprise liquid cellulose-rich organic waste selected from the group consisting of agricultural wastewater, animal manure, industrial wastewater (e.g., pulp or paper wastewater, etc.), textile wastewater, municipal wastewater (e.g., liquid human sewage, etc.), and beverage manufacturer wastewater. The feedstock may comprise any other type of solid or liquid cellulose-rich organic waste, and such solid or liquid cellulose-rich organic waste is not limited to the aforementioned non-limiting examples. Additionally, it is to be appreciated that such aforementioned solid or liquid cellulose-rich organic waste is typically readily available, abundant, and inexpensive.

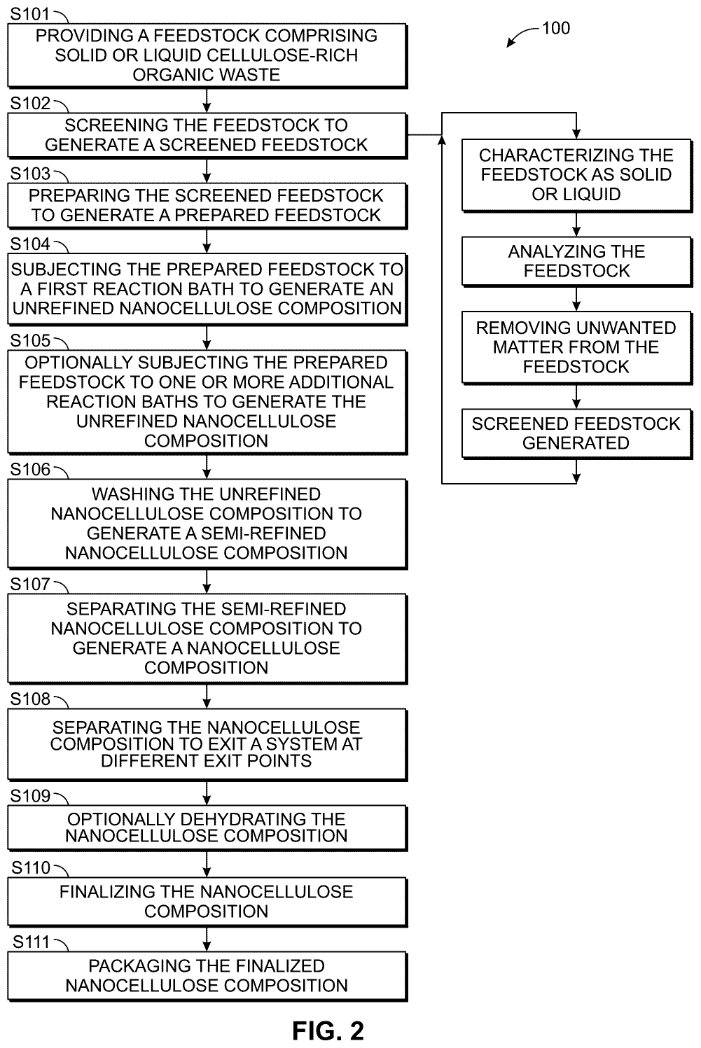

Referring to FIG. 2, once the feedstock has been provided from step S101, the method 100 may proceed to step S102 thereof. According to at least one embodiment, step S102 of the method 100 includes screening the feedstock to generate a screened feedstock. In this regard, according to at least one embodiment, the step S102 of screening the feedstock to generate the screened feedstock may include characterizing the feedstock as solid or liquid, analyzing the feedstock, and removing unwanted matter from the feedstock.

More specifically, with further regard to step S102 of the method 100, as shown in FIG. 2, the feedstock may be characterized as solid or liquid. With further regard to step S102 of the method 100, once the feedstock has been characterized such that the feedstock has been determined to be solid or liquid, as further shown in FIG. 2, the feedstock may be analyzed. According to at least one embodiment, as non-limiting examples, analyzing the feedstock may include determining at least one of the weight, density, chemical composition, water/moisture content (RH), acidity (pH), or electrical conductivity (EC) of the feedstock. Other qualities and quantities of the feedstock may be analyzed, and are not limited to the aforementioned non-limiting examples. Moreover, such analyzed qualities and quantities of the feedstock may be determined or measured by scales, moisture analyzers, Spectro methods, or by using optics methods. With further regard to step S102 of the method 100, once the feedstock has been analyzed, as further shown in FIG. 2, unwanted matter may be removed from the feedstock. According to at least one embodiment, as non-limiting examples, removing the unwanted matter from the feedstock may include removing at least one of metal particles (e.g., iron particles, copper particles, nickel particles, or other metal particles), plastic particles (e.g., PLA particles, PVC particles, PET particles, or other plastic particles), synthetic fibers (e.g., polyester, etc.), glass particles, dirt particles, dust particles, sand particles, soil particles, construction aggregate particles, dead skin particles, ions, hair particles, perfluoroalkyl and polyfluoroalkyl substances (PFAS), fats, oils, detergents (e.g., clothing laundry detergents or other detergents used for washing fabrics and other textiles), or dyes (e.g., clothing dye chemicals, fabric dye chemicals, or other textile dye chemicals) from the feedstock. Other unwanted matter may be removed from the feedstock, and is not limited to the aforementioned non-limiting examples. The various unwanted matter may be removed from the feedstock by way of various equipment, processes, or techniques, as may be understood by those skilled in the art. For example, to remove metal particles, a magnet is preferably used. Additionally, gravity, a centrifuge, or precipitation could be used to remove unwanted matter such as sand particles or particles that are relatively heavy. Moreover, dirt particles, soil particles, and heavy particles may be removed by cyclones. Further, oils may be removed by oil separators, and density separation, size separation by vibrating, or other screening may also be used to remove the unwanted matter. The unwanted matter removed from the feedstock may be further recycled so as to be environmentally-friendly.

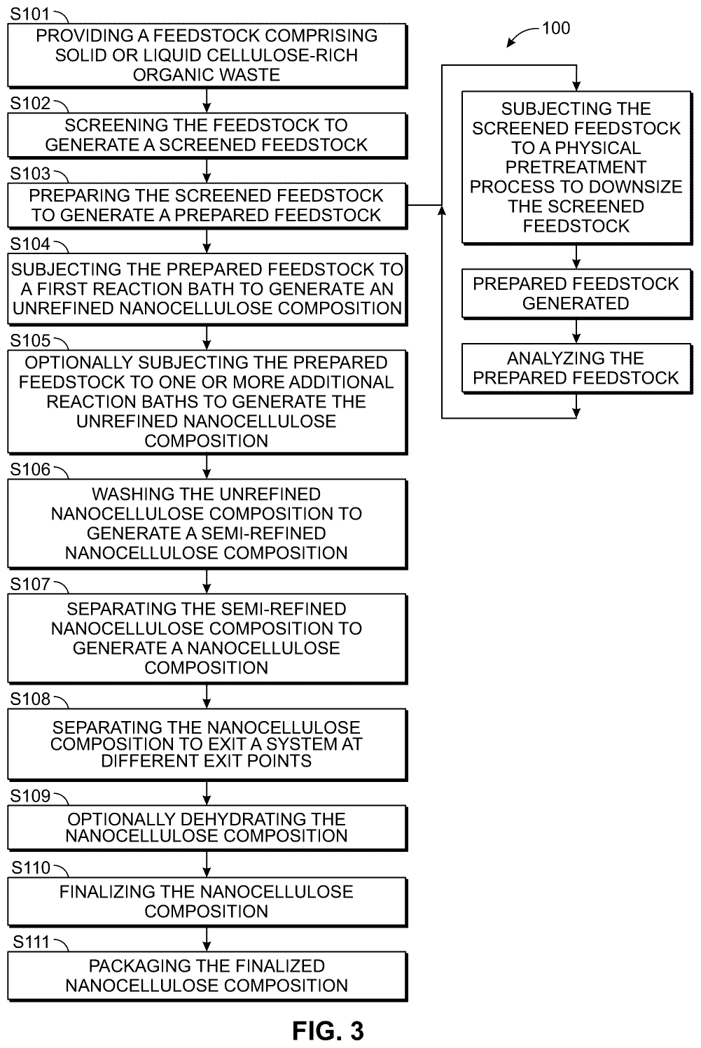

Referring to FIG. 3, once the screened feedstock has been generated from step S102, the method 100 may proceed to step S103 thereof. According to at least one embodiment, step S103 of the method 100 includes preparing the screened feedstock to generate a prepared feedstock. In this regard, as shown in FIG. 3, according to at least one embodiment, the step S103 of preparing the screened feedstock to generate the prepared feedstock may include subjecting the screened feedstock to a physical pretreatment process to downsize the screened feedstock and generate the prepared feedstock. Moreover, as shown in FIG. 3, according to at least one embodiment, the step S103 of preparing the screened feedstock to generate the prepared feedstock may further include analyzing the prepared feedstock after the screened feedstock has been downsized so as to generate the prepared feedstock.

More specifically, with further regard to step S103 of the method 100, according to at least one embodiment, as non-limiting examples, subjecting the screened feedstock to the physical pretreatment process to downsize the screened feedstock may include subjecting the screened feedstock to at least one of a grinding process, a cutting process, a high-pressure homogenization process, a shear homogenization process, an electron beam process, a radiation process, a cavitation process, a sonication process, a vibration process, or a crushing process. Other physical pretreatment processes may be used to downsize the screened feedstock, and are not limited to the aforementioned non-limiting examples. Moreover, the particular physical pretreatment process may depend on such factors as whether the screened feedstock is solid or liquid, screened feedstock water content, screened feedstock chemical composition, bio solids in wastewater concentration of the screened feedstock, etc. Downsizing the screened feedstock (i.e., into smaller physical particles) by way of the physical pretreatment process advantageously allows the screened feedstock to be treated and processed more efficiently in subsequent steps of the method 100 that will be further described herein. With further regard to step S103 of the method 100, once the screened feedstock has been downsized by way of the physical pretreatment process so as to generate the prepared feedstock, as further shown in FIG. 3, the prepared feedstock may be analyzed to verify the prepared feedstock is ready to proceed to the subsequent step S104 of the method 100, which will be described later herein. According to at least one embodiment, as non-limiting examples, analyzing the prepared feedstock may include determining at least one of the weight, volume, acidity (pH), temperature, viscosity, or electrical conductivity (EC) of the prepared feedstock. Other qualities, quantities, reaction parameters, etc. of the prepared feedstock may be analyzed, and are not limited to the aforementioned non-limiting examples. Moreover, such analyzed qualities, quantities, reaction parameters, etc. of the prepared feedstock may be measured by scales, moisture analyzers, Spectro methods, or by using optics methods.

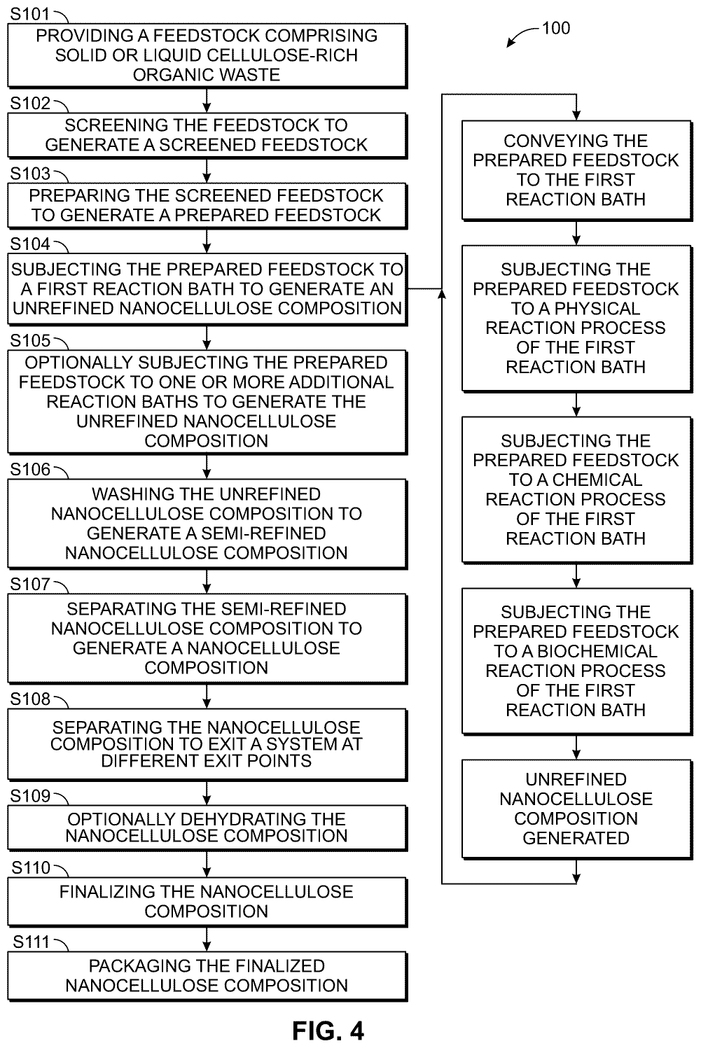

Referring to FIG. 4, once the prepared feedstock has been generated from step S103, the method 100 may proceed to step S104 thereof. According to at least one embodiment, step S104 of the method 100 includes subjecting the prepared feedstock to a first reaction bath to generate an unrefined nanocellulose composition. In this regard, the first reaction bath, and any subsequent reaction baths (i.e., step S105), is capable of physically and chemically altering the prepared feedstock so as to physically and chemically break down (i.e., downsize) the cellulose fibers of the prepared feedstock (i.e., to a nano-sized scale), thereby generating the unrefined nanocellulose composition. As shown in FIG. 4, according to at least one embodiment, the step S104 of subjecting the prepared feedstock to the first reaction bath to generate the unrefined nanocellulose composition may include conveying the prepared feedstock to the first reaction bath, subjecting the prepared feedstock to a physical reaction process of the first reaction bath, and subjecting the prepared feedstock to a chemical reaction process of the first reaction bath to generate the unrefined nanocellulose composition. Moreover, as shown in FIG. 4, according to at least one embodiment, the step S104 of subjecting the prepared feedstock to the first reaction bath to generate the unrefined nanocellulose composition may include subjecting the prepared feedstock to a biochemical reaction process of the first reaction bath to generate the unrefined nanocellulose composition.

More specifically, with further regard to step S104 of the method 100, according to at least one embodiment, as non-limiting examples, conveying the prepared feedstock to the first reaction bath may include conveying the prepared feedstock to the first reaction bath by way of a conveyor netting, a pump, gravity, or air pressure. Other conveying apparatus or techniques may be used to convey the prepared feedstock to the first reaction bath and are not limited to the aforementioned non-limiting examples. With further regard to step S104 of the method 100, as shown in FIG. 4, once the prepared feedstock has been conveyed to the first reaction bath, the prepared feedstock may be subjected to the physical reaction process of the first reaction bath, the chemical reaction process of the first reaction bath, and/or the biochemical reaction process of the first reaction bath. With further regard to step S104 of the method 100, according to at least one embodiment, as non-limiting examples, subjecting the prepared feedstock to the physical reaction process of the first reaction bath may include subjecting the prepared feedstock to at least one of a grinding process, a high-pressure homogenization process, a shear hydrolysis homogenization process, a hydrolysis process, a cavitation process, an electron beam process, a radiation process, a sonication process, a vibration process, a heating process, or a crushing process of the first reaction bath. Other physical reaction processes may be used to carry out the first reaction bath, and are not limited to the aforementioned non-limiting examples. The physical reaction process of the first reaction bath may refine, separate, and break down (i.e., downsize) the cellulose fibers of the prepared feedstock. With further regard to step S104 of the method 100, according to at least one embodiment, as non-limiting examples, subjecting the prepared feedstock to the chemical reaction process of the first reaction bath may include adding and mixing at least one selected from the group consisting of boric acid, formic acid, phosphoric acid, sodium hydroxide, hydrogen peroxide, trioxygen, citric acid, acetic acid, hydrobromide, hydrochloric acid, nitric acid, liquid ions, eutectic solvents, sodium chlorite, ethanol, carboxylic acid, phosphoric based acid, sulfuric based acids, TEMPO, polyethylene amine, deionized water, water, and any combination thereof, with the prepared feedstock. With further regard to step S104 of the method 100, according to at least one embodiment, as a non-limiting example, subjecting the prepared feedstock to the biochemical reaction process of the first reaction bath may include adding and mixing hydrolysis enzymes with the prepared feedstock. The particular chemicals, enzymes, etc. to be added and mixed with the prepared feedstock to carry out the chemical reaction process and/or the biochemical reaction process of the first reaction bath may depend on factors such as whether the prepared feedstock is solid or liquid, acidity (pH), electrical conductivity (EC), temperature, water content, viscosity, etc. As previously mentioned, such chemicals, enzymes, etc. described above may be used to carry out the chemical reaction process and/or the biochemical reaction process of the first reaction bath, however, other chemicals, enzymes, etc. not specifically mentioned may also be used to carry out the chemical reaction process and/or the biochemical reaction process of the first reaction bath. With further regard to step S104 of the method 100, the first reaction bath may also contain drainage for any liquids, and may sensor to monitor the acidity (pH), temperature, and electrical conductivity (EC), as well as the particle size of the generated unrefined nanocellulose composition. The physical and chemical reaction processes of the first reaction bath may range from 1 second to 1 day, a reaction temperature of the first reaction bath may range from 1 to 400° F., and the reaction pressure of the first reaction bath may range between −5 and 5 atm.

Still referring to FIG. 4, once the unrefined nanocellulose composition has been generated from step S104, the method 100 may proceed to step S105 thereof. According to at least one embodiment, step S105 of the method 100 includes optionally subjecting the prepared feedstock to one or more additional reaction baths, after the first reaction bath, to generate the unrefined nanocellulose composition. More specifically, with further regard to step S105 of the method 100, optional additional reaction baths (i.e., similar or varied) to the first reaction bath may be carried out (e.g., up to 50 or more additional reaction baths) to further physically and chemically break down (i.e., downsize) the cellulose fibers of the prepared feedstock (i.e., to a nano-sized scale), thereby generating the unrefined nanocellulose composition. In between each additional reaction bath, the liquid may be replaced, and various chemicals, enzymes, etc. may be added to the particular reaction bath to result in each reaction bath having a particular downsizing effect on the cellulose fibers of the prepared feedstock. In this regard, any number of additional reaction baths may be carried out until the desired unrefined nanocellulose composition is generated.

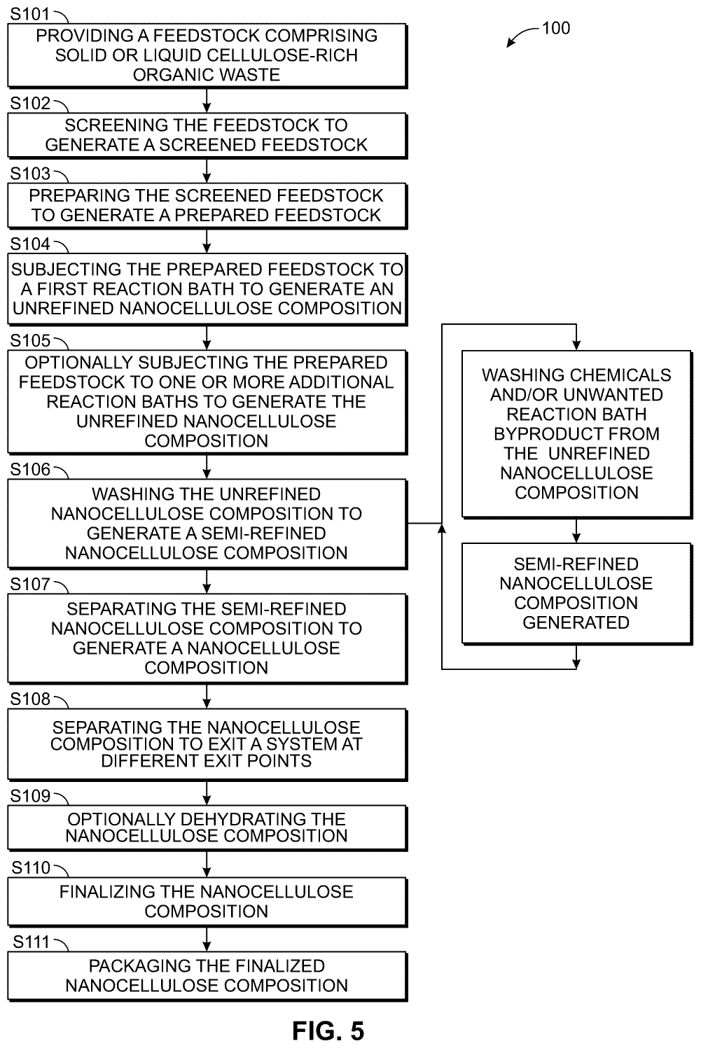

Referring to FIG. 5, once the unrefined nanocellulose composition has been generated from step S104 and/or step S105 (i.e., in the case where the prepared feedstock has been optionally subjected to one or more additional reaction baths to generate the unrefined nanocellulose composition), the method 100 may proceed to step S106 thereof. According to at least one embodiment, step S106 of the method 100 includes washing the unrefined nanocellulose composition to generate a semi-refined nanocellulose composition. More specifically, with further regard to step S106 of the method 100, according to at least one embodiment, as non-limiting examples, washing the unrefined nanocellulose composition to generate the semi-refined nanocellulose composition may include washing the unrefined nanocellulose composition by way of a water immersion process, a water spray process, a dialysis process, a reverse osmosis process, or an acid removal process to thereby wash chemicals and/or unwanted reaction bath byproduct (i.e., further ending any ongoing reactions) from the unrefined nanocellulose composition and generate the semi-refined nanocellulose composition. Other washing processes or techniques may be used to wash the chemicals and/or unwanted reaction bath byproduct from the unrefined nanocellulose composition and are not limited to the aforementioned non-limiting examples.

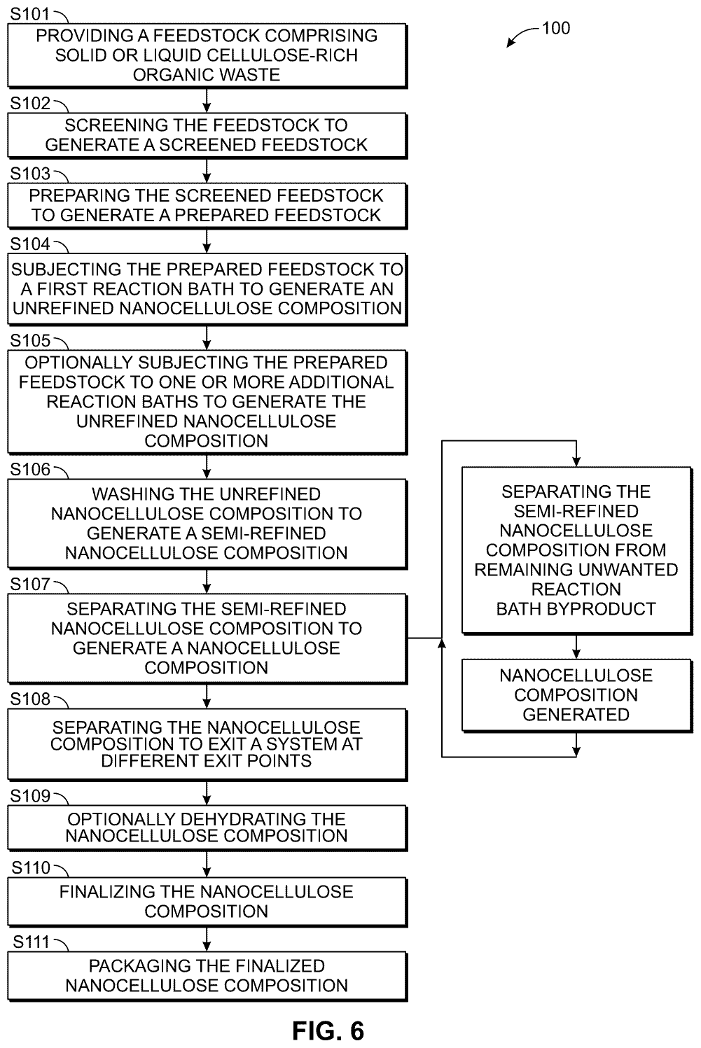

Referring to FIG. 6, once the semi-refined nanocellulose composition has been generated from step S106, the method 100 may proceed to step S107 thereof. According to at least one embodiment, step S107 of the method 100 includes separating the semi-refined nanocellulose composition to generate a nanocellulose composition. More specifically, with further regard to step S107 of the method 100, according to at least one embodiment, separating the semi-refined nanocellulose composition to generate the nanocellulose composition may include separating the semi-refined nanocellulose composition from remaining unwanted reaction bath byproduct (e.g., that still remains from step S106) to generate the nanocellulose composition. The semi-refined nanocellulose composition may be separated from the remaining unwanted reaction bath byproduct by way of various separation equipment or techniques, as may be understood by those skilled in the art. Moreover, according to at least one embodiment, the nanocellulose composition may be undehydrated and in the form of a gel after the semi-refined nanocellulose composition is separated from the remaining unwanted reaction bath byproduct to generate the nanocellulose composition.

Still referring to FIG. 6, once the nanocellulose composition has been generated from step S107, the method 100 may proceed to step S108 thereof. According to at least one embodiment, step S108 of the method 100 includes separating the nanocellulose composition to exit a system (e.g., the particular system or machine at which the method 100 is carried out) at different exit points (i.e., places or areas). More specifically, with further regard to step S108 of the method 100, the separating of the nanocellulose composition to exit the system at different exit points may be based on particle size and/or quality (e.g., zeta potential) of the nanocellulose composition. In this regard, as non-limiting examples, various size separation techniques, electro spin, or other spin technologies may be used to separate the nanocellulose composition to exit the system at the different exit points.

Still referring to FIG. 6, once the nanocellulose composition has been separated to exit the system at different exit points from step S108, the method 100 may proceed to step S109 thereof. According to at least one embodiment, step S109 of the method 100 includes optionally dehydrating the nanocellulose composition to remove any water or moisture from the nanocellulose composition and further physically stabilize the nanocellulose composition. In this regard, the nanocellulose composition that is optionally dehydrated is initially in gel form, then may be in powder form after being dehydrated. As such, according to at least one embodiment, the nanocellulose composition that has been optionally dehydrated may be in the form of a powder.

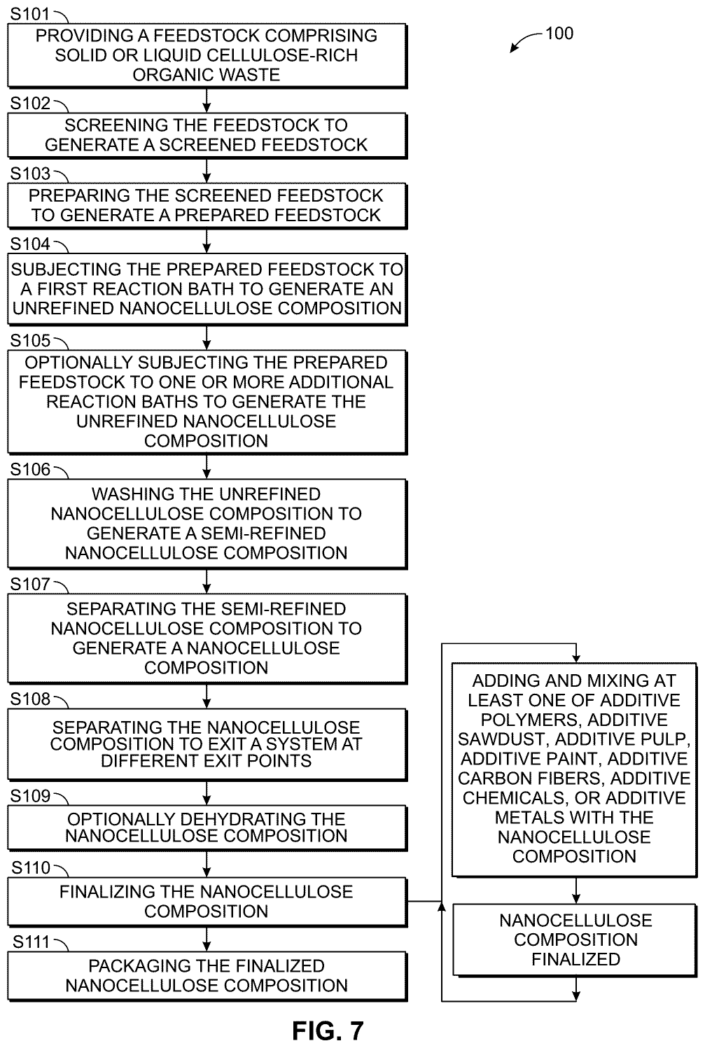

Referring to FIG. 7, once the nanocellulose composition has been separated to exit the system at different exit points from step S108, and/or has been optionally dehydrated from step S109, the method 100 may proceed to step S110 thereof. According to at least one embodiment, step S110 of the method 100 includes finalizing the nanocellulose composition. In at least one embodiment, as non-limiting examples, finalizing the nanocellulose composition may include adding and mixing at least one of additive polymers, additive sawdust, additive pulp, additive paint, additive carbon fibers, additive chemicals, or additive metals with the nanocellulose composition to finalize the nanocellulose composition. Adding such additive polymers, additive sawdust, additive pulp, additive paint, additive carbon fibers, additive chemicals, additive metals, etc. to the nanocellulose composition may advantageously customize the nanocellulose composition for specific uses and applications in various industries. Moreover, according to at least one embodiment, the nanocellulose composition may be in the form of a powder or a gel after the nanocellulose composition has been finalized (i.e., depending on whether the nanocellulose composition has been optionally dehydrated in step S109 of the method 100).

Still referring to FIG. 7, once the nanocellulose composition has been finalized from step S110, the method 100 may proceed to step S111 thereof. According to at least one embodiment, step S111 of the method 100 includes packaging the nanocellulose composition after the nanocellulose composition has been finalized. More specifically, as non-limiting examples, the nanocellulose composition that has been finalized (i.e., finalized nanocellulose composition) may be packaged in boxes, containers, etc. in gel, powder, or other forms. Once packaged, the finalized nanocellulose composition is ready to be sent to customers, clients, etc.

While one or more embodiments are described above, it is not intended that the one or more embodiments describe all possible forms encompassed by the claims. The words used in the specification are words of description rather than limitation, and it is understood that various changes may be made without departing from the spirit and scope of the disclosure. The features of various embodiments may be combined to form further embodiments of the disclosure that may not be explicitly described or illustrated.

With regard to any methods, processes, etc., described herein, it should be understood that, although the steps of such methods, processes, etc. have been described as occurring according to a certain ordered sequence, such methods, processes, etc. could be practiced with the described steps performed in an order other than the order described herein. It should be further understood that certain steps could be performed simultaneously, that other steps could be added, or that certain steps described herein could be omitted. In other words, the descriptions of any methods, processes, etc. described above are provided for the purpose of illustrating certain embodiments, and should in no way be construed so as to limit the claims.

As used in this specification and claims, the terms “for example”/(“e.g.”), “for instance”, “such as”, and “like”, and the verbs “comprising”, “having”, “including”, and their other verb forms, when used in conjunction with a listing of one or more carriers or other items, are each to be construed as open-ended, meaning that the listing is not to be considered as excluding other, additional carriers or items. Other terms are to be construed using their broadest reasonable meaning unless they are used in a context that requires a different interpretation.

What is claimed is:

1. A method of producing a nanocellulose composition from solid or liquid cellulose-rich organic waste, the method comprising:
providing a feedstock comprising solid or liquid cellulose-rich organic waste;
screening the feedstock to generate a screened feedstock;
preparing the screened feedstock to generate a prepared feedstock;
subjecting the prepared feedstock to a first reaction bath to generate an unrefined nanocellulose composition;
washing the unrefined nanocellulose composition to generate a semi-refined nanocellulose composition; and
separating the semi-refined nanocellulose composition to generate a nanocellulose composition.

2. The method according to claim 1, wherein the feedstock comprises solid cellulose-rich organic waste selected from the group consisting of solid agricultural waste, solid industrial waste, solid textile waste, solid municipal waste, and solid forestry waste.

3. The method according to claim 1, wherein the feedstock comprises liquid cellulose-rich organic waste selected from the group consisting of agricultural wastewater, animal manure, industrial wastewater, textile wastewater, municipal wastewater, and beverage manufacturer wastewater.

4. The method according to claim 1, wherein screening the feedstock to generate the screened feedstock includes characterizing the feedstock as solid or liquid, analyzing the feedstock, and removing unwanted matter from the feedstock.

5. The method according to claim 4, wherein analyzing the feedstock includes determining at least one of the weight, density, chemical composition, water/moisture content (RH), acidity (pH), or electrical conductivity (EC) of the feedstock.

6. The method according to claim 4, wherein removing the unwanted matter from the feedstock includes removing at least one of metal particles, plastic particles, synthetic fibers, glass particles, dirt particles, dust particles, sand particles, soil particles, construction aggregate particles, dead skin particles, ions, hair particles, PFAS, fats, oils, detergents, or dyes from the feedstock.

7. The method according to claim 1, wherein preparing the screened feedstock to generate the prepared feedstock includes subjecting the screened feedstock to a physical pretreatment process to downsize the screened feedstock and generate the prepared feedstock.

8. The method according to claim 7, wherein subjecting the screened feedstock to the physical pretreatment process to downsize the screened feedstock includes subjecting the screened feedstock to at least one of a grinding process, a cutting process, a high-pressure homogenization process, a shear homogenization process, an electron beam process, a radiation process, a cavitation process, a sonication process, a vibration process, or a crushing process.

9. The method according to claim 7, wherein preparing the screened feedstock to generate the prepared feedstock further includes analyzing the prepared feedstock after the screened feedstock has been downsized, and wherein analyzing the prepared feedstock includes determining at least one of the weight, volume, acidity (pH), temperature, viscosity, or electrical conductivity (EC) of the prepared feedstock.

10. The method according to claim 1, wherein subjecting the prepared feedstock to the first reaction bath to generate the unrefined nanocellulose composition includes conveying the prepared feedstock to the first reaction bath, subjecting the prepared feedstock to a physical reaction process of the first reaction bath, and subjecting the prepared feedstock to a chemical reaction process of the first reaction bath to generate the unrefined nanocellulose composition.

11. The method according to claim 10, wherein conveying the prepared feedstock to the first reaction bath includes conveying the prepared feedstock to the first reaction bath by way of a conveyor netting, a pump, gravity, or air pressure.

12. The method according to claim 10, wherein subjecting the prepared feedstock to the physical reaction process of the first reaction bath includes subjecting the prepared feedstock to at least one of a grinding process, a high-pressure homogenization process, a shear hydrolysis homogenization process, a hydrolysis process, a cavitation process, an electron beam process, a radiation process, a sonication process, a vibration process, a heating process, or a crushing process of the first reaction bath.

13. The method according to claim 10, wherein subjecting the prepared feedstock to the chemical reaction process of the first reaction bath includes adding and mixing at least one selected from the group consisting of boric acid, formic acid, phosphoric acid, sodium hydroxide, hydrogen peroxide, trioxygen, citric acid, acetic acid, hydrobromide, hydrochloric acid, nitric acid, liquid ions, eutectic solvents, sodium chlorite, ethanol, carboxylic acid, phosphoric based acid, sulfuric based acids, TEMPO, polyethylene amine, deionized water, water, and any combination thereof, with the prepared feedstock.

14. The method according to claim 10, wherein subjecting the prepared feedstock to the first reaction bath to generate the unrefined nanocellulose composition further includes subjecting the prepared feedstock to a biochemical reaction process of the first reaction bath to generate the unrefined nanocellulose composition.

15. The method according to claim 14, wherein subjecting the prepared feedstock to the biochemical reaction process of the first reaction bath includes adding and mixing hydrolysis enzymes with the prepared feedstock.

16. The method according to claim 1, further comprising optionally subjecting the prepared feedstock to one or more additional reaction baths, after the first reaction bath, to generate the unrefined nanocellulose composition.

17. The method according to claim 1, wherein washing the unrefined nanocellulose composition to generate the semi-refined nanocellulose composition includes washing the unrefined nanocellulose composition by way of a water immersion process, a water spray process, a dialysis process, a reverse osmosis process, or an acid removal process to thereby wash chemicals and/or unwanted reaction bath byproduct from the unrefined nanocellulose composition and generate the semi-refined nanocellulose composition.

18. The method according to claim 1, wherein separating the semi-refined nanocellulose composition to generate the nanocellulose composition includes separating the semi-refined nanocellulose composition from remaining unwanted reaction bath byproduct to generate the nanocellulose composition.

19. The method according to claim 18, wherein the nanocellulose composition is undehydrated and is in the form of a gel.

20. The method according to claim 18, further comprising separating the nanocellulose composition to exit a system at different exit points, wherein the separating of the nanocellulose composition is based on particle size and/or quality of the nanocellulose composition.

21. The method according to claim 20, further comprising optionally dehydrating the nanocellulose composition.

22. The method according to claim 21, wherein the nanocellulose composition that has been optionally dehydrated is in the form of a powder.

23. The method according to claim 20, further comprising finalizing the nanocellulose composition, wherein finalizing the nanocellulose composition includes adding and mixing at least one of additive polymers, additive sawdust, additive pulp, additive paint, additive carbon fibers, additive chemicals, or additive metals with the nanocellulose composition to finalize the nanocellulose composition.

24. The method according to claim 23, wherein the nanocellulose composition is in the form of a powder or a gel after the nanocellulose composition has been finalized.

25. The method according to claim 23, further comprising packaging the nanocellulose composition after the nanocellulose composition has been finalized.
